(19) United States
(12) Patent Application Publication
(10) Pub. No.: US 2023/0185361 A1
(43) Pub. Date: Jun. 15, 2023

(54) SYSTEM AND METHOD FOR REAL-TIME CONFLICT MANAGEMENT AND SAFETY IMPROVEMENT

(71) Applicant: Christopher Phillips Lierle, Vancouver, WA (US)

(72) Inventor: Christopher Phillips Lierle, Vancouver, WA (US)

(21) Appl. No.: 17/955,536

(22) Filed: Sep. 28, 2022

Related U.S. Application Data
(60) Provisional application No. 63/249,911, filed on Sep. 29, 2021.

(51) Int. Cl. G06F 3/01; G06V 40/16; G06V 40/20

(52) U.S. Cl. CPC G06F 3/011; G06V 40/176; G06V 40/23; G06F 2203/011

(57) ABSTRACT

A real-time conflict management system has a computer system. A microphone is coupled to the computer system. A video capture device is coupled to the computer system. A biometric device is coupled to the computer system. Interactions are recorded onto the computer system using the microphone and video capture device. A first feature of the interaction is extracted based on data from the microphone and video capture device while recording the interaction. A metric is calculated based on the first feature. A conflict intervention strategy is deployed in response to a change in the metric. The triggering of the conflict intervention is recorded.

### CLAIM OF DOMESTIC PRIORITY

The present application claims the benefit of and priority to U.S. Provisional Application Ser. No. 63/249,911, filed Sep. 29, 2021, entitled “Method, Device and Equipment for the Detection and Intervention of Fear, Anger, and Other Emotions” which is hereby incorporated herein by reference, in its entirety for all that it teaches and for all purposes.

### TECHNICAL FIELD

This invention relates generally to the field of real-time human interaction analysis, and more specifically to a new and useful system and method for promoting and achieving a reduction in unsafe conflict/communication, as well as a reduction in harm resulting therefrom.

### BACKGROUND

Conflict is an inevitable part of life. Handled well, it brings people together and solves problems; handled poorly, it is a source of potential harm—to individuals, families, organizations, and even society itself. Words and actions during non-productive conflict can, and do, create lasting damage in both direct and indirect ways. From the personal and societal costs of emotional and physical violence to the estimated $359 billion loss that US corporations suffer every year due to conflict, or the simple tragedy of increased heart disease and early death among men who handle conflict unproductively, the overall toll of unproductive conflict is truly staggering. Despite these huge costs, unproductive conflict rolls through society like a natural disaster, largely unchecked. The prior art consists largely of self-help books and call-center software designed to alert call handlers to the ire of an unhappy caller. There is no current system or method to detect unproductive conflict and intervene to assist in making it productive. This invention provides such a new and useful system and method.

### BRIEF DESCRIPTION OF THE FIGURES

FIG. 1 illustrates a group of people engaging in an intense conversation;

FIG. 2 illustrates a computer system to monitor interactions and provide real-time feedback;

FIG. 3 illustrates an electronic communication network used by the computer system to communicate with a computer server;

FIG. 4 illustrates a cloud network;

FIG. 5 illustrates a computer application utilizing a plurality of software engines;

FIG. 6 illustrates a flow or process diagram of a method providing an alert to a user in response to a deviation from the expected state;

FIG. 7 illustrates physical and other presentation inputs to a interaction analysis engine;

FIG. 8 illustrates a supervised machine learning classification algorithm;

FIG. 9 illustrates initial setup of the real-time conflict management system;

FIG. 10 illustrates an activity selection screen of the real-time conflict management system;

FIG. 11 illustrates a presentation being analyzed to provide real-time feedback and scores and ratings for the presentation;

FIG. 12 illustrates a summary screen of the public speaking training system after completion of a presentation;

FIG. 13 shows examples of use cases for a real-time conflict management system

### DESCRIPTION OF THE EMBODIMENTS

The following description of the embodiments of the invention is not intended to limit the invention to these embodiments but rather to enable a person skilled in the art to make and use this invention.

### 1. Overview

A system and method for detecting conflict and interacting autonomously with one or more persons involved in the conflict, and possibly taking additional actions (e.g., recording audio/video and/or alerting authorities), to increase the likelihood of a safe and productive outcome. The system and method are preferably designed to function as a neutral third party that acts during a conflict to promote safe resolution. The system and method can include a casing with sensor components to monitor for conflict; output components that provide feedback interaction with the conflict-involved persons; and additional processing, control, communication, and power components. The system and method preferably incorporate modular components and multiple possible casings, enabling the simple customization of the apparatus to meet the requirements of a variety of users (e.g., children or adults), environments (e.g., a person's home or an outdoor construction site), and use cases (e.g., personal use or workplace safety use).

The users of the system and method can be any person or group of persons who communicate. In some embodiments, the system and method are portable/wearable and therefore primarily used to address conflicts near and/or involving that single user. In some embodiments, the system and method can be installed in a fixed physical location to address conflicts that may occur there. In some embodiments, multiple instances of the system and method can be networked together to address conflict across a large physical area. In some embodiments, the user is also the purchaser and administrator, such as with a wearable device. In some embodiments, a purchaser (such as a corporation) would employ the system and method to address conflict among users (e.g., employees), with the system and method administered by authorized personnel (e.g., human resources staff). Organizations most likely to benefit from this system and method are those where personal safety is critically important (including, but not limited to: schools, daycare facilities, and elder care homes) or where conflict is highly likely (including, but not limited to: mediation services locations, tax offices, and licensing agencies).

In particular, the system and method simulates a knowledgeable and impartial third party by taking independent actions aimed at increasing personal and public safety during the conflict. It does so by detecting that conflict is happening; monitoring the ongoing conflict; continuously assessing the safety threat posed by the conflict; selecting its own actions based on that threat level; implementing those actions; and returning to monitoring the conflict to identify what new action(s), if any, should be taken. Examples of its possible actions include, but are not limited to: playing audio/visual content, such as a soothing tone or a reminder of conflict management strategies; recording video/audio of the conflict; alerting authorities; or providing other feedback, such as haptic feedback (if using a wearable embodiment). The system and method may take more than one action at a time (e.g., recording a conflict while notifying authorities).

### DETAILED DESCRIPTION

The present invention is described in one or more embodiments in the following description with reference to the figures, in which like numerals represent the same or similar elements. While the invention is described in terms of the best mode for achieving objectives of the invention, those skilled in the art will appreciate that the disclosure is intended to cover alternatives, modifications, and equivalents as may be included within the spirit and scope of the invention as defined by the appended claims and claims equivalents as supported by the following disclosure and drawings.

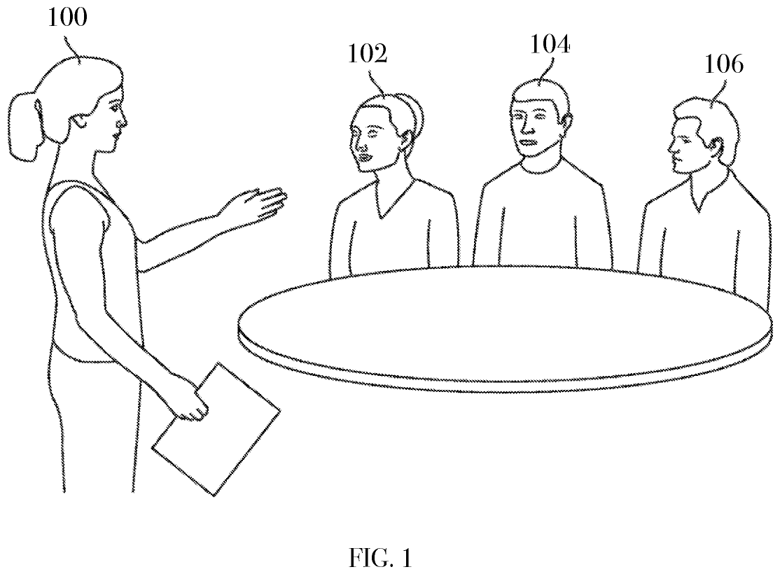

FIG. 1: A real-time conflict detection and harm mitigation system. A user 100 interacts with one or more other individuals 102, 104, 106. The system observes the interaction and all persons in range via various inputs, including optical, audio, and biometric inputs, and is able to detect conflict occurring and take real-time actions during the conflict to reduce the potential harm from the conflict.

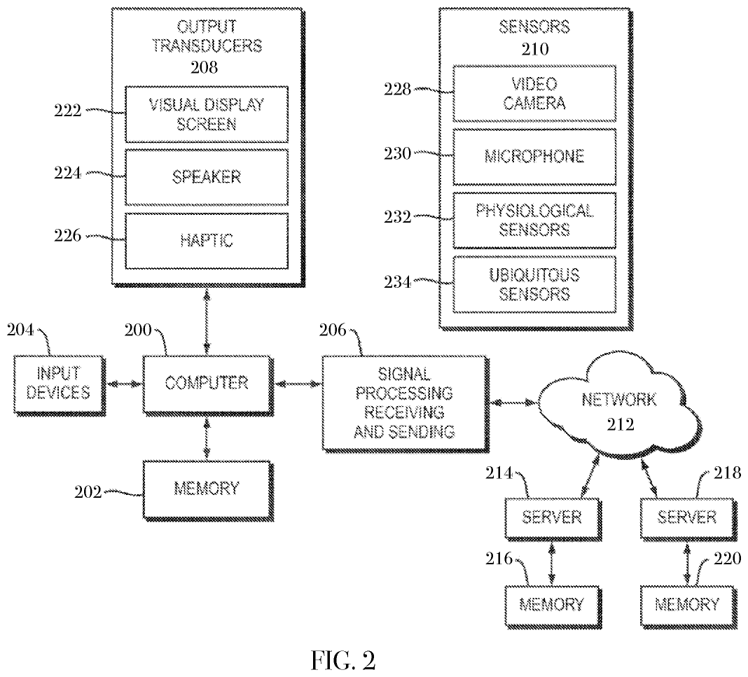

FIG. 2 is a block diagram of hardware used in a conflict mitigation device. In the example shown in FIG. 2, sensors 210 gather data about one or more human users during an interpersonal interaction. The sensors 210 include a video camera (e.g., webcam) 228, microphone 230, physiological sensors 232, and ubiquitous sensors 234. Output transducers 208 provide humanly perceptible feedback to a human user. The output transducers 208 include a visual display screen 222, speaker 224, and haptic transducer 226.

A computer 200 receives sensor data from the sensors 210 and input data from input devices 204 and/or input data via the network 212 from an Administrator's computer. The input devices 204 may include a mouse, keyboard, touch screen, haptic input device, or other I/O (input/output) devices. The computer 200 may write data to, or read data from, an electronic memory 202. The computer 200 may be connected to a network (e.g., the Internet) 212 via apparatus for signal processing and for receiving and sending data 206. Through the network 212, the computer 200 may interface with servers (e.g., 214, 218) that control the system and UI. The servers (e.g., 214, 218) may store data in, and retrieve data from, memory devices (e.g., one or more hard drives) 216, 220. The computer can be administered by authorized users; this can be done on an Administrator's computer, which is networked to the device computer 200, or directly on the computer 200 itself via input devices 204.

Program code for the Administrator system is distributed via a portable mass storage medium, such as a compact disk (CD), digital versatile disk (DVD), or thumb drive. The program may also be downloaded over the internet or another network. Program code for the Administrator system is initially stored in mass storage. The program code is downloaded over the internet directly to mass storage, or the program code is installed from a CD or DVD onto mass storage. In some embodiments, the program code runs from the CD or DVD rather than being installed onto mass storage. In other embodiments, the program code comes preloaded on the machine.

Data from sensors 210 streams to the computer 200, which handles the data as instructed by the program code of the Administrator system and applies analysis algorithms to the data from sensors 210 to assess if a conflict is occurring; if so, to calculate the likelihood of harm occurring due to the conflict; and then generate situationally-appropriate outputs, which are distributed via the output transducers 208. In some embodiments, the computer 200 sends select streaming data from input sensors 210 to other computers, such as a local server or cloud server for analysis.

The network 212 represents any hardware device of computer system 200 capable of communicating with other computer systems and servers. In one embodiment, the network 212 is reached via a wired or wireless Ethernet adapter. The network 212 represents a network cable or a wireless link to another computer system or to a local network router.

The display 222 shows a graphical user interface with contents controlled by executing the program code of the conflict mitigation software. While user 100 is engaged in conflict, the display 222 may show content based on the nature of the conflict and the system's chosen intervention(s).

Display 222 is integrated into computer system 200 in some embodiments, such as when computer system 200 is a cell phone, smartwatch, tablet, virtual reality headset, or stand-alone conflict mitigation device. In other embodiments, display 222 is an external monitor connected to computer system 200 via a video cable.

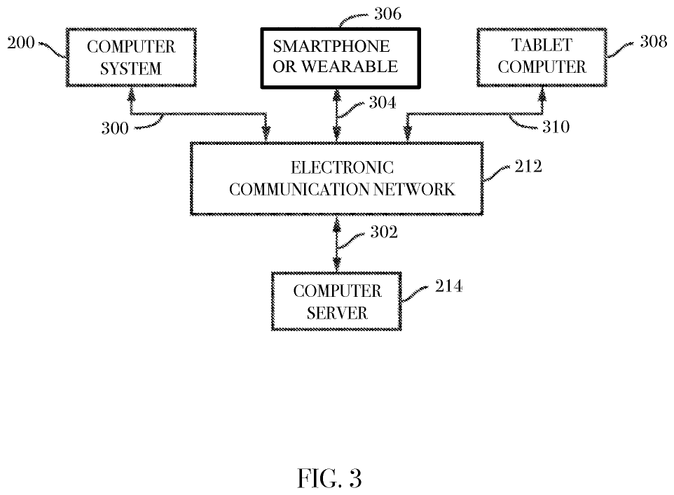

FIG. 3 illustrates an electronic communication network 212 that computer system 200 connects to via communication link 300. Electronic communication network 212 represents any digital network, such as the internet, a private wide-area network (WAN), a corporate network, or a home local area network (LAN). Electronic communication network 212 includes a plurality of network cables, switches, routers, modems, and other computer systems as necessary to route data traffic between computer system 200 and other computer systems connected to the electronic communication network.

Computer system 200 is located at a home, office, or other location accessible by user 100. Computer system 200 communicates with computer server 214 via electronic communication network 212. Data packets generated by computer system 200 are output through communication link 300. Electronic communication network 212 routes the data packets from the location of computer system 200 to the location of computer server 214. Finally, the packets travel over communication link 302 to computer server 214. Computer server 214 performs any processing necessary on the data, and returns a message to computer system 200 via a data packet transmitted through communication link 302, electronic communication network 212, and communication link 300. Computer server 214 also stores the data received from computer system 200 to a database or other storage in some embodiments.

The smartphone or wearable watch 306 is connected to electronic communication network 52 via communication link 304, and tablet computer 308 is connected to the electronic communication network via communication link 310. Communication links 304 and 310 can be cellular telephone links, such as 5G or 4G/LTE, in some embodiments. Cell phone/smartwatch 306 and tablet computer 308 are portable computer systems that allow user 100 to utilize the public speaking feedback system from any location with cellular telephone service or Wi-Fi.

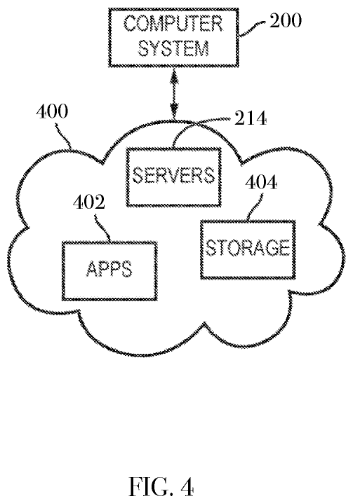

FIG. 4 illustrates cloud network 400. Cloud network 400 represents a system of servers 212, applications 402, and remote storage 404 that computer system 200 connects to and utilizes via communication link 300 and electronic communication network 212. Computer system 200 utilizes functionality provided by servers 214, applications 402 served by or running on servers 214 or other servers, and remote storage 404 located at servers 214 or in other locations. Servers 214, apps 402, and storage 404 are all used by user 100 connecting to a single uniform resource locator (URL), or using a single application on computer system 200, even though apps 402 and storage 404 may exist across a plurality of computer servers 214. Computer system 200 connects to the various computer resources of cloud network 400 transparently to user 100, necessary to perform the functionality of the conflict mitigation program.

Cloud 400 is used in some embodiments to serve the program code for the conflict mitigation program to computer system 200 for use by the Administrator to review specific past incidents handled by the conflict mitigation program. The Administrator program exists as an application 402 in cloud 400 rather than on a mass storage device local to computer system 200. The administrator visits a website for the feedback program by entering a URL into a web browser running on computer system 200. Computer system 200 sends a message requesting the program code for the Administrator software from a server 214. Server 214 sends the application 402 corresponding to the Administrator software back to computer system 200 via electronic communication network 212 and communication link 302. Computer system 200 executes the program code and displays visual elements of the application in the web browser being used by user 100.

In some embodiments, the program code for the conflict mitigation application is executed on server 214. Server 214 executes the application 402 requested by the Administrator, and simply transmits any output to computer system 200. Computer system 200 streams the physical input data representing the Administrator's input (such as selecting a new setting for the conflict mitigation system), and any other data required for the Administrator program, to servers 214 via network 212. Servers 212 stream data (e.g., confirmation of a change to settings) back to computer system 200.

Besides serving the Administrator program as an application 402, cloud 400 is also used to analyze the sensor 210 data generated by user 100 in some embodiments. As computer system 200 analyzes an interaction involving user 100, the computer system streams collected data to servers 214 for analysis. Servers 214 execute program code that analyzes the inputs from Microphone 230 (e.g., the text of the interaction, as well as vocal characteristics indicating emotion), Video Camera 228 (e.g., body language, motion, and/or emotional cues), and Physiological Sensors 234 (e.g., heart rate) to determine any interventions that should be provided to user 100. Cloud 400 can be used to analyze input data whether the conflict mitigation program exists as an application 402 on cloud 400, or if the program code is installed and executed locally to computer system 200. In other embodiments, the program code running on computer system 200 performs all the sensor data locally to the computer system without transmitting the presentation data to servers 214 on cloud 400.

A third use of cloud 400 is as remote storage and backup for interaction data captured by the conflict mitigation program. Computer system 200 sends video, audio, and other data captured during a conflict to servers 214 which store the data in cloud storage 404 for future use. In some embodiments, all video, audio, and other input data from Sensors 210 are stored in storage 404. In other embodiments, only data related to incidents of possible conflict that were detected and mitigated by computer system 200 or servers 214 is stored in cloud storage 404. The data in storage 404 is used by the Administrator at future times to evaluate system effectiveness, note the actions of specific people, send information to authorities, or for any other purpose.

Conflict mitigation data for a plurality of users can be aggregated within storage 404 for review by a manager or supervisor at a company implementing the conflict mitigation system across an entire employee base. Results for multiple users could also be reviewed by an appropriate Administrator in non-corporate settings, as well. Such person logs into the Administrator program connected to cloud 400 to view aggregate conflict data by employee, location, manager, or other categorization. The Administrator program can be hosted on cloud 400 as an application 402. The Administrator program accesses conflict data in storage 404 and presents a dashboard to the Administrator. The dashboard shows data on productive conflict as well as potentially harmful conflict. The manager can review employee performance and assess how well employees are progressing important skill sets. In embodiments where user 100 is simply an individual seeking to handle conflict better, system data can be stored on mass storage locally to computer system 200, rather than on storage 404 of cloud 400.

The Administrator and conflict mitigation programs can be run totally on computer system 200, or may be run completely on cloud 400 and simply be displayed on computer system 200 or any of the output transducers 208. Any subset of the previously described cloud functionality may be used in any combination in the various embodiments. In one embodiment, the functionality of the feedback application is implemented completely on cloud 400, while in other embodiments the functionality runs completely on computer system 200. In some embodiments, the functionality is split between cloud 400 and computer system 200 in any combination.

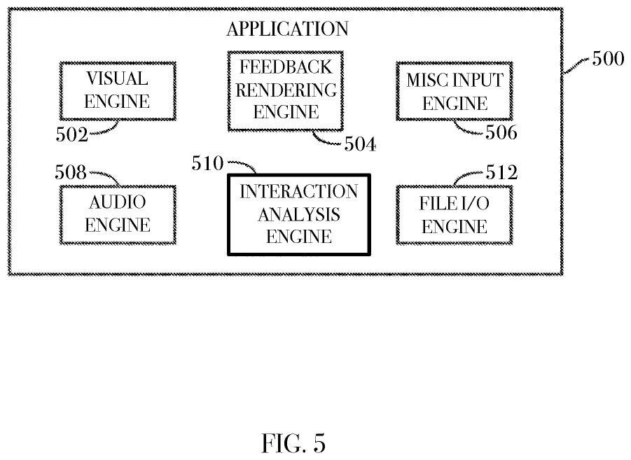

FIG. 5 illustrates the conflict mitigation application 500 including a plurality of software engines providing the functionality of the application. Application 500 can be stored on mass storage as an installed program, stored in memory for execution, or stored in cloud 400 for remote access. A software engine can be a library, a software development kit, or other object that denotes a block of software functionality. Software developers can purchase engines pre-designed by third parties to provide certain functionality of application 500, and thereby prevent having to completely rewrite the program code for functionality that has already been adequately implemented by others. Engines can also be written from scratch for the unique functionality required to run application 500.

Application 500 includes a visual engine 502, action selection engine 504, misc input engine 506, audio engine 508, conflict analysis engine 510, and file input and output (I/O) engine 512. Other engines not illustrated are used in other embodiments to implement other functionality of application 500.

Visual engine 502 interfaces with the visual input hardware of computer system 200. Visual engine 502 allows application 500 to capture visual input from a video camera 228 connected to computer system 200 and display video output through the visual display screen 222 connected to computer system 200 without the programmer of application 500 having to understand each underlying operating system or hardware call.

Action selection engine 504 is used to render output for the conflict mitigation program. The output is rendered by application 500 simply by making an application programming interface (API) call to the conflict analysis engine 510, and then processing the data received to select which intervention/output to employ, if any.

Application 500 uses action selection engine 504 to render the output for all output transducers 208. For example, for haptic feedback, application 500 uses action selection engine 504 to generate haptic output to provide the user with important real-time alerts to alter the course of the conflict.

Misc input engine 506 interfaces with the various other input hardware of computer system 200. These miscellaneous inputs include haptic, biometric, and other inputs. Misc input engine 506 allows application 500 to capture input from an input device 210 connected to computer system 200 and output through an associated output transducer 208 connected to computer system 200 without the programmer of application 500 having to understand each underlying operating system or hardware call.

Audio engine 508 interfaces with the sound hardware of computer system 200. Audio engine 508 allows application 500 to capture audio from a microphone connected to computer system 200 and play audio through speakers connected to computer system 200 without the programmer of application 500 having to understand each underlying operating system or hardware call.

Conflict analysis engine 510 receives the audio, video, biometric, and other data captured during a conflict event, extracts features of the conflict from the data and generates metrics, statistics, timelines, transcripts, descriptions and histories. Conflict analysis engine 510 is critical functionality of conflict mitigation application 500 and is programmed from scratch. However, in some embodiments, specific functionality required to observe and extract features from a conflict event is implemented using 3rd party software.

File I/O engine 512 allows application 500 to read and write data from mass storage, RAM, and storage 404 of cloud 400. File I/O engine 512 allows the programmer creating application 500 to utilize various types of storage, e.g., cloud storage, FTP servers, USB thumb drives, or hard drives, without having to understand each required command for each kind of storage.

Application 500 modularizes functionality into a plurality of software engines to simplify a programmer's task. Engines can be purchased from third parties where the functionality has already been created by others. For functionality new to application 500, engines are created from scratch. Each engine used includes an API that a programmer uses to control the functionality of the engine. An API is a plurality of logical functions and data structures that represent the functionality of an engine. Audio engine 504 includes an API function call to play a sound file through speakers of computer system 200, or to read any cached audio information from the microphone.

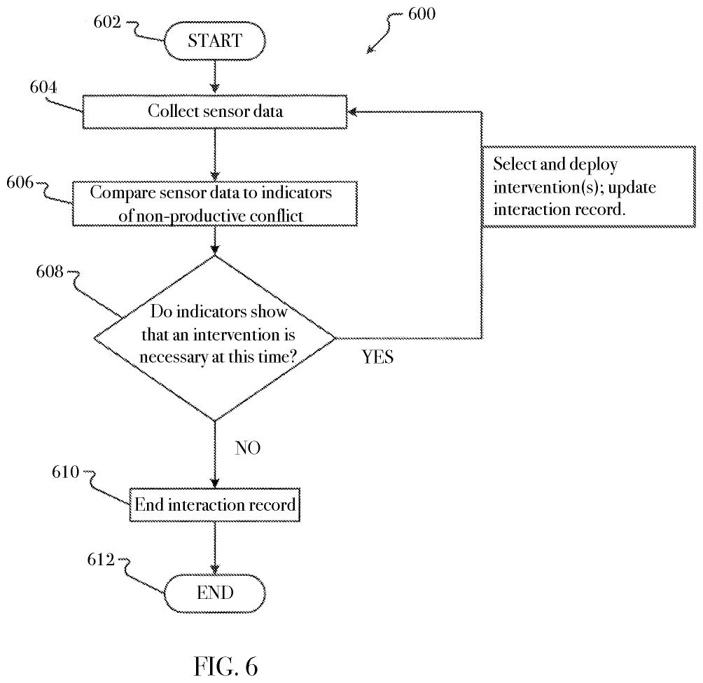

FIG. 6: An embodiment of a method 600 of providing feedback to user 200 in response to a deviation from the expected interaction is represented in FIG. 6. A general order for the steps of the method 600 is shown in FIG. 6. Generally, method 600 starts with a start operation 602 and ends with an end operation 612. The method 600 can include more or fewer steps or can arrange the order of the steps differently than those shown in FIG. 6. Additionally, although the operations of method 600 may be described or illustrated sequentially, many of the operations may in fact be performed in parallel or concurrently. The method 600 can be executed as a set of computer-executable instructions executed by a computer system 200 and encoded or stored on the computer system 200.

The feedback system 200 can collect data related to the user 100 from sensors 210 in step 604. The data may comprise information related to the user's voice or interaction, or contain information from other sensory inputs such as video, haptic, and biometric. In one embodiment, the sensor data comprises one or more of intensity, pitch, pace, frequency, and loudness (for example, in decibels), interaction cadence, spectral content, micro tremors and any other information related to the user's voice recorded by one or more sensors 210. The sensor data may also include biometric data, such as pulse rate, respiration rate, temperature, blood pressure, movement of the user, and information about the user's eyes from the sensors 210. In one embodiment, the sensor data includes data received from a device 228, 230, 232, 234 in communication with the feedback device 200.

The analysis engine 510 may then compare the collected sensor data to the response-triggering state for non-productive conflict in step 606. In this manner, the analysis engine 510 can determine whether the sensor data is associated with the intervention-triggering state defined by a machine-learning based analysis of non-productive conflict. The analysis engine 510 may compare the volume of the user's voice to ambient noise levels to determine if the user's voice is too loud, for example. By evaluating one or more of the pitch, pace, frequency, volume, cadence, and micro tremors included in the user's voice, as well as other sensory inputs, the analysis engine 510 can determine if an intervention should be launched to assist the user 100 with navigating the conflict productively.

If the sensor data does not indicate an intervention is needed, method 600 may return via NO to collecting new sensor data, in step 608. In this way, the sensor data is periodically or continually collected and analyzed by the analysis engine 510 to determine whether the sensor data is associated with the intervention-triggering state. If the sensor data does indicate an intervention-triggering condition is present, method 600 proceeds via YES to operation 610.

In operation 610 the computer system 200 selects and triggers a situationally-appropriate intervention. The intervention may include providing an alert to the user via the output transducers 208. The intervention can be at least one of audible, visible, and haptic. In one embodiment, the intervention is provided by the feedback device 222. Additionally, or alternatively, the intervention is generated by a device 224 or 226. In one embodiment, the system 200 analyzes sensor input for emotional content, specific word usage, and video signs of non-productive conflict, using these (and possible other inputs, such as biometric data, to decide if an intervention is warranted, and if so, which one(s) to launch in operation 610. In some embodiments, the interventions available may range from a calming tone; to audible instruction on how to immediately de-escalate; to warnings of consequences; to notification of other parties, possibly up to and including law enforcement. The system 200 may execute one or more of these sequentially, simultaneously, or some combination thereof.

Additionally, or alternatively, the alert provided in operation 610 may include providing a notification to another device. For example, if the computer system 200 determines that the user 100 is experiencing an emotional state associated with loss of emotional control, the alert of operation 610 may include notifying another person, such as a supervisor or security officer, by contacting that person's device using network 212.

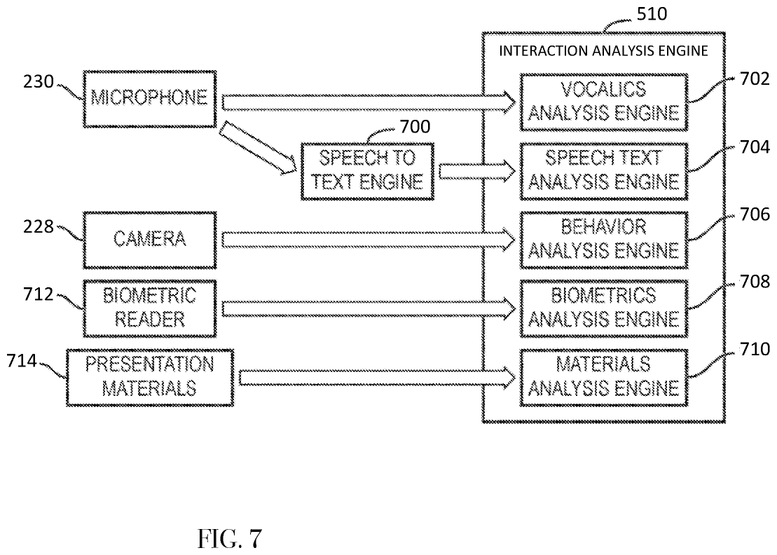

FIG. 7 illustrates interaction analysis engine 510. Interaction analysis engine 510 receives signals from the various input peripherals 210 of computer system 200 and analyzes the inputs to extract features of the interaction and generate metrics used by application 500 to identify conflict. The inputs to interaction analysis engine 510 include microphone 230, camera 228, and a biometric reader 712. The audio from microphone 230 is routed through interaction to text engine 700 to generate text of the words that user 100 is speaking. The text from interaction to text engine 700 is routed as an additional input to interaction analysis engine 510. interaction analysis engine 510 includes a vocalics analysis engine 702, a text analysis engine 704, a behavior analysis engine 706, a biometrics analysis engine 708, and a materials analysis engine 710 if printed or electronic materials (such as documents, slides, multimedia, etc.) are in use as the conflict occurs.

Microphone 230 is electrically connected to a line-in or microphone audio jack of computer system 200. Microphone 230 converts analog audio signals in the environment, e.g., interaction from user 100, to an analog electrical signal representative of the sounds. Audio hardware of computer system 200 converts the analog electrical signal to a series of digital values which are then fed into vocalics analysis engine 702 of interaction analysis engine 510. In other embodiments, microphone 140 generates a digital signal that is input to computer system 200 via a Universal Serial Bus (USB) or other port.

In one embodiment, useful for (but not limited to) training users, microphone 230 is a part of a headset worn by user 100. The headset includes both headphones for audio output by computer system 200 to user 100, and microphone 230 attached to the headphones. The headset allows for noise cancellation by computer system 200, and improves the audio quality for the presentation received by interaction to text engine 700 and vocalics analysis engine 702.

Vocalics analysis engine 702 analyzes the sound generated by user 100, rather than the content of the words being spoken. By analyzing the sound from user 100, vocalics engine 702 identifies indicators of conflict, including (but not limited to) a change in tone, pace, pitch, and/or volume of the user's interaction. Vocalics analysis engine 510 may also analyze the rhythm, intonation, and intensity of the user's voice. Vocalics analysis engine 702 provides a conflict likelihood score based on the properties of the voice of user 100.

Speech-to-text engine 700 converts the audio signal of the voice of user 100 into text representative of the words being spoken by the user. The text from speech to text engine 700 is provided as an input to speech text analysis engine 704. Text analysis engine 704 analyzes the content of the words spoken by user 100. Text analysis engine 704 performs natural language processing and determines if indicators of non-productive conflict are present.

Those indicators may involve language varying from subtle (an expression of contempt) to obvious (a profanity-laden yell of rage). Text analysis engine 704 assesses the words being spoken for such signs, assigning a score to the likelihood of non-productive conflict indicated by the text. For example, user 100 may trigger the system to assign a very high likelihood of non-productive conflict by saying, “You are a moron” to another person, or even by spelling an insult or profane word out loud.

Behavior analysis engine 706 receives a video stream of user 100 and the person(s) with whom they are interacting. The video feed is received by application 500 from camera 228 and routed to behavior analysis engine 706. Behavior analysis engine 706 looks at the behavior of user 100, and all other individuals in frame, for body movement, posture, gestures, facial expression, and eye contact. Behavior analysis engine 706 looks at body movement, gestures, and posture of user 100, et al., to generate a score indicating the likelihood that the interaction comprises non-productive conflict.

Other peripheral devices may supplement the information received from camera 228. In one embodiment, two cameras 228 are used. Parallax between the two cameras 228 helps give the behavior analysis engine 154 a depth of view and better gauge the position and motion of each body part of user 100, et al, to look for signs of non-productive conflict.

The facial expressions of user 100, et al, are monitored as an input by the behavior analysis engine 706, which scores facial expressions as being indicative or not indicative of conflict, and outputs this score to application 500.

Eye tracking of user 100, et al, also factors into the analysis of the likelihood of conflict. The video of user 100, et al, is captured by camera 228, and behavior analysis engine 706 analyzes the image to determine where each person is looking. Behavior analysis engine 706 determines the likelihood of the specific amount of eye contact indicating a state of conflict and outputs this score to application 500.

Behavior analysis engine 706 creates a log of each interaction and the scores it created at the moment, as does each engine in the system. In the event non-productive conflict is detected, the application 500 creates a file for human review, whether that be for personal coaching/development, disciplinary purposes, or even as evidence to provide to law enforcement.

In some embodiments, a separate camera 228 is zoomed in to capture a high-quality image of the face of user 100, et al. In embodiments with a separate camera 228 for facial recognition, a first camera 228 is zoomed back to capture the entire interaction, while one or more additional camera(s) 228 are zoomed in on the faces of participants to capture higher quality images for better facial recognition and expression analysis. Object tracking can be used to keep the second camera trained on the face of each participant, even if the participant moves around during the interaction.

Biometric reader 712 reads biometrics of user 100 and transmits a data feed representing the biometrics to biometrics analysis engine 708. Biometrics analyzed by biometrics analysis engine 708 may include, but are not limited to: blood pressure, heart rate, sweat volume, temperature, breathing rate, etc. Biometric devices 712 are located on the body of user 100 to directly detect biometrics, or are deployed at a distance and remotely detect biometrics. In one embodiment, biometric reader 712 is an activity tracker that user 100 wears as a bracelet, watch, necklace, or piece of clothing, that connects to computer system 200 via Bluetooth or Wi-Fi or another suitable technology. The activity tracker detects heartbeat and other biometrics of user 100 and transmits the data to computer system 200. In some embodiments, biometric reader 712 provides information as to movements of user 100 which are routed to behavior analysis engine 706 to help the behavior analysis engine analyze body movements of the user.

Materials Analysis Engine 710 stores and analyzes the content of any materials in use during the conflict. For example, a presentation might contain the core of the non-productive conflict, adding needed context to any review of the interaction. Materials Analysis Engine 710 analyzes the text using much the same method as the

Each analysis engine 702-710 of interaction analysis engine 510 outputs features as user 100 interacts with others. When indicators of conflict pass a predetermined threshold, a result signal is generated by a respective analysis engine 702-710. Application 500 captures the interaction and performs further analysis to determine overall scores and ratings of the situation, select appropriate levels of intervention, and provide real-time information to participants to help de-escalate non-productive conflict. Application 500 captures the results and outputs of analysis engines 702-710, and analyzes the results based on predetermined metrics and thresholds. It also notes the interventions it has deployed during the interaction, and chooses its next intervention, if any, accordingly.

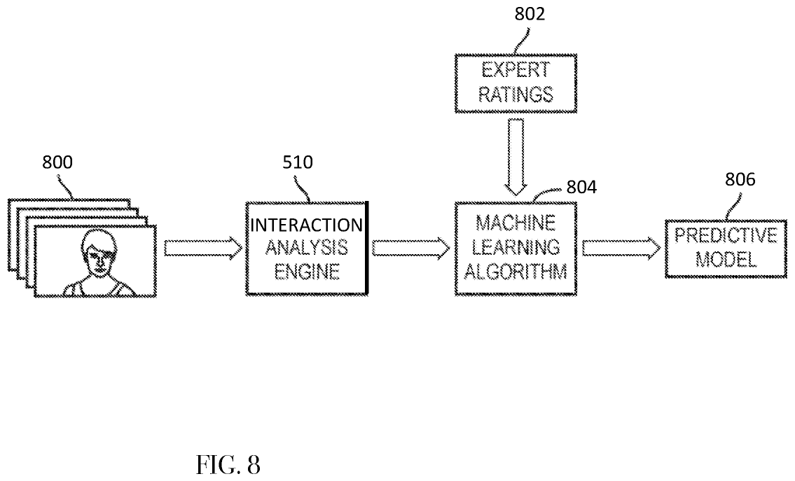

To interpret the features and metrics from interaction analysis engine 510, a supervised machine classification algorithm is used, as illustrated in FIG. 8. Pre-recorded interactions 800 are input into interaction analysis engine 510 to extract features and generate metrics for each of the pre-recorded interactions. The features and metrics from interaction analysis engine 510, as well as scores 802 provided by experts who have observed the interactions 800, are input into machine learning algorithm 804. Machine learning algorithm 804 is used to generate a predictive model 806. Predictive model 806 defines correlations between features and metrics from interaction analysis engine 510 and ratings 802 of interactions 800 provided by conflict experts.

Thousands of interactions 800 are input into interaction analysis engine 510 to form the basis of predictive model 806. A wide variety of conflict interactions, both good and bad (productive and non-productive), are input into the machine learning algorithm. Each interaction is input into interaction analysis engine 510 to generate the same features and metrics that will be generated by analysis application 500. In addition, experts are employed to observe interactions 800 and provide ratings 802 based on the experts' individual opinions. In one embodiment, six conflict experts rate each individual interaction 800 to provide the expert ratings 802. In another embodiment, historic interactions 800 are used and historic evaluators are used to provide expert ratings 802.

Machine learning algorithm 804 receives the features and metrics from interaction analysis engine 510, as well as the expert ratings 802, for each interaction 800. Machine learning algorithm 804 compares the key features and metrics of each interaction 800 to the ratings 802 for each interaction, and outputs predictive model 806. Predictive model 806 includes rating scales for individual metric parameters and features used by application 500 to provide conflict-likeliness score. Predictive model 806 defines what features make a conflict productive or non-productive.

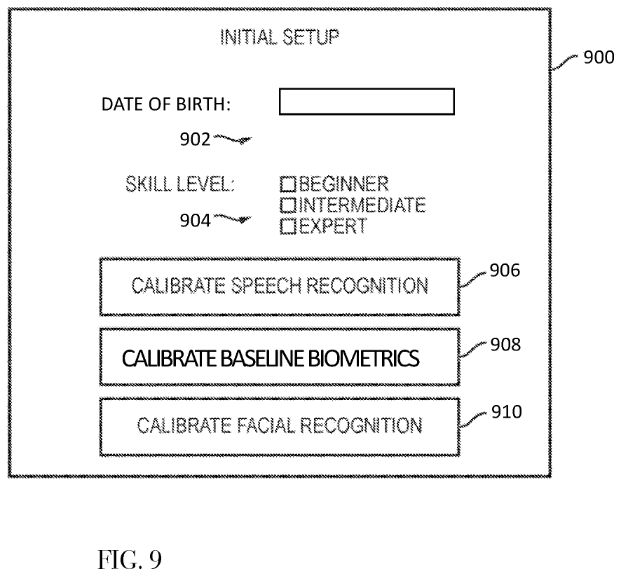

FIG. 9: Interactions are compared against predictive model 806 to provide conflict-likeliness scores, trigger real-time interventions (as necessary), and/or provide tips and feedback to the persons involved via text, email, or other networked communication system. Prior to involvement in conflict for analysis by application 500, user 100 may perform an initial setup and calibration as shown in FIG. 9. FIG. 9 shows computer window or screen 222 with setup and calibration options 900-910.

Date of Birth 902 helps interaction analysis engine 510 interpret data from microphone 230, particularly in identifying a specific user across several years (especially children). Skill level option 904 tells application 500 an approximate starting level for the conflict resolution skills of user 100. Setting skill level option 904 accurately helps application 500 adjust thresholds for feedback during training exercises. A beginner will have a higher threshold that must be reached before triggering an alert. An expert will get feedback for smaller details.

Options 906-910 take user 100 to other screens where calibration occurs. Calibrate interaction recognition option 906 takes user 100 to a screen that walks the user through a calibration process to learn the voice and speaking mannerisms of the user. User 100 is prompted to speak certain words, phrases, and sentences. The calibration process analyzes how user 100 speaks helps the application 500 identify the user 100, and creates baseline data to interpret subsequent interactions using interaction-to-text engine 700. Proper calibration also helps application 500 generate an accurate textual representation of speech by user 100, which improves analysis accuracy of the content of the presentation.

Calibrate eye tracking 908 takes user 100 to a screen where application 500 is calibrated to better recognize where exactly the user is looking. User 100 is asked to move to various locations in the room, and look at directions dictated by application 500. Application 500 analyzes the face of user 100 from various angles and with eyes looking in various directions, and saves a model of the user's face for use in determining where the user is looking during an interaction. In one embodiment, the eye tracking calibration routine displays a dot that moves around display 222 while the eye calibration routine accesses video camera 228 to observe the eye movement and position of user 100 following the dot.

Calibrate facial recognition 910 is used to learn the features of the face of user 100. Photos of the face of user 100 are taken with webcam 228 from various angles, and the user is also prompted to make various facial expressions for analysis. User 100 may also be asked to confirm the exact location of facial features on a picture of her face. For instance, user 100 may be asked to touch the tip of their nose and the corners of their mouth on a touchscreen to confirm the facial recognition analysis. Facial recognition calibration helps interaction analysis engine 510 accurately determine the emotions being expressed by user 100 while interacting. In one embodiment, facial recognition of training application 500 is fully automatic, and no calibration is required to track mouth, chin, eyes, and other facial features. In other embodiments, calibration is not required but may be used for enhanced precision.

In one embodiment, after setup and calibration is completed using page 900, application 500 uploads the configuration data to storage 404 of cloud 400. Uploading configuration data to cloud storage 404 allows user 100 to log into other computer systems and have all the calibration data imported for accurate analysis. User 100 can configure application 500 on a home personal computer, and then interact in front of any device in the conflict detection network, as it is automatically set up and calibrated to the user's voice and face by downloading configuration data from cloud storage 404. In some embodiments, a portion of the calibration is required to be performed again if a new type of device is used, or when a different size of screen is used.

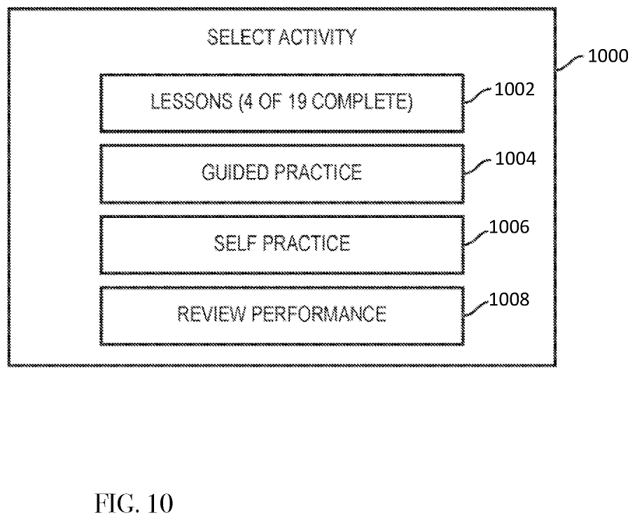

FIG. 10 shows a screen 1000 used by user 100 to begin a feedback session using application 500. User 100 can launch the live presentation mode using option 1002, guided practice with option 1004, self-practice with option 1006, or review the analysis of past interactions with option 1008.

Clicking or touching Lessons button 1002 takes user 100 to a set of conflict resolution training modules. In one embodiment, after pressing Lessons button 1002, user 100 is asked to answer questions to demonstrate their knowledge of the subject matter, possibly enabling them to skip to the most relevant material.

User 100 does guided practice by clicking or touching button 1004. In guided practice, application 500 generates a hypothetical scenario for user 100 to practice handling an interaction. Application 500 gives user 100 a sample conflict and choices for how to proceed, or gives prompts for the user to answer as two actors act out a conflict scenario. User 100 provides requested input, and then application 500 rates the user's performance.

Self-practice is performed by clicking or pressing self-practice button 1006. Self-practice allows user 100 to practice an interaction. In one embodiment, after pressing self-practice button 1006, user views actors portraying a conflict situation, and responds verbally after each character speaks, either indicating that what the actor said was correct, or speaking other words that would have been more effective in promoting constructive conflict resolution.

Review Interactions button 1008 allows user 100 to review each of their own real-life past interactions that were saved by the system, to see what went right and what went wrong, review tips and feedback, or watch the interaction as a whole. In addition to analysis and recordings of each past interaction user 100 has completed, application 500 presents summaries of performance trends over time. If user 100 has been steadily improving certain skills while other skills have stayed steady or worsened, the user will be able to see those trends under Review Interactions button 1008.

The Review Interaction screen 1008 will also allow users to share the results and trends in their interactions with other individuals or export to other formats. In some embodiments, the user is able to share their results to their employer, professor or other supervisory entities.

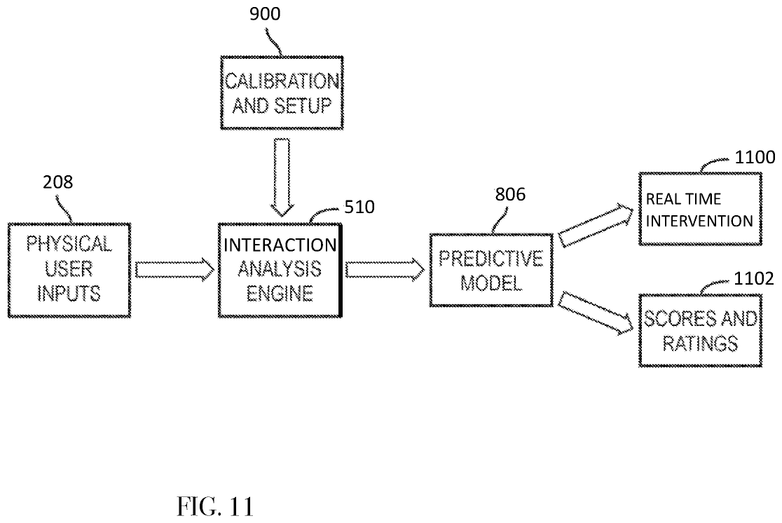

FIG. 11 illustrates the process of application 500 analyzing an interaction involving user 100. Physical user inputs 210 from input peripherals 228, 230, 712, 714, etc. are provided to interaction analysis engine 510. Interaction analysis engine 510 interprets physical user inputs 210 with the aid of the calibration and setup 900 that the user previously performed. Interaction analysis engine 510 outputs identified features, calculated metrics, and other information that application 500 interprets through predictive model 806 to generate real-time interventions 1100 and scores and ratings 1102.

Physical user inputs 208 include microphone 230, camera 230, and biometric reader 712. User 100 also provides any presentation materials 714 being used if available. Interaction analysis engine 510 receives the physical data generated by user 100 during an interaction, and analyzes the user's vocal characteristics for signs of non-productive conflict. Calibration 900 helps speech analysis engine 510 analyze physical inputs 208 because the interaction analysis engine becomes aware of certain idiosyncrasies in the way user 100 pronounces certain words, or the way the user smiles or expresses other emotions through facial expressions.

Interaction analysis engine 510 extracts features and generates metrics in real-time as user 100 performs a presentation. The features and metrics are all optionally recorded for future analysis, and are routed to predictive model 806 for comparison against various thresholds contained within the predictive model. Based on how the interaction by user 100 compares to the interactions 800 that were expertly rated, application 500 generates real-time interventions during the interaction, if necessary, and saves the scores and ratings it used to arrive at its decision.

Real-time Intervention 1100 may come in the form of alerts and notifications. Application 500 provides optional audible, haptic, and on-screen alerts and advice. Application 500 may display a graph of certain metrics over time that user 100 can keep an eye on during the interaction. An audible ding may be used every time user 100 uses a verbal distractor to train the user not to use distractors. A wearable may vibrate when user 100 has five minutes left in their allotted presentation time. Real-time feedback is configurable, and application 500 includes an option to completely disable real-time feedback 1100. User 100 presents uninterrupted and reviews all feedback after the presentation.

Scores and ratings 1102 are available via application 500 when user 100 completes an interaction. Scores and ratings 1102 reflect the features and metrics of an entire interaction and may be based on peaks, averages, or ranges of metric values. Multiple scores are provided which are each based on a different combination of the metrics and features generated by interaction analysis engine 510. In one embodiment, one overall score is presented, which combines all of the interaction attributes.

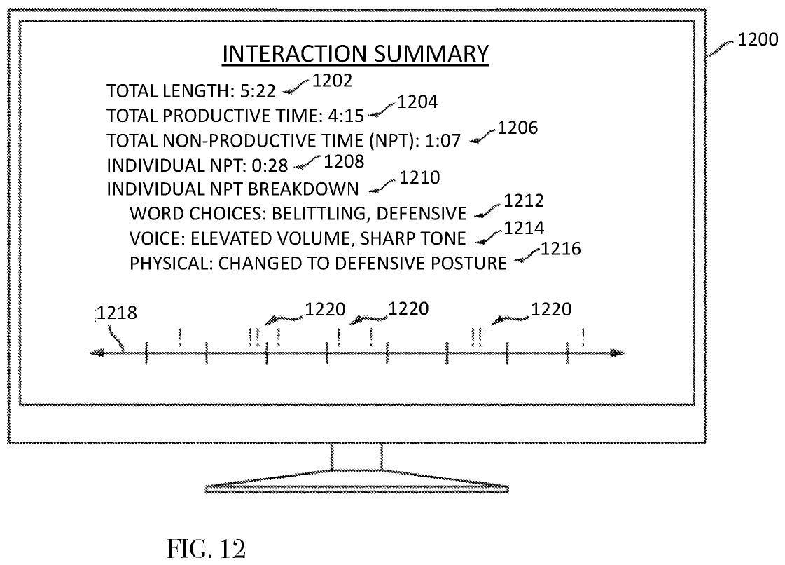

FIG. 12 illustrates a summary page that is displayed when accessing a specific stored interaction. Application 500 provides a summary 1200 of the interaction, the part the user 100 played therein, and access to both the raw data (video/sound/text of the interaction), as well as the system's analysis of each part. Application 500 reports total interaction time 1202, and can also notify user 100 how much of that interaction time was productive 1204. The Total Non-Productive Time (NPT) 1206 is displayed and is the basis for all additional information in the Summary. The amount of time the user 100 spent contributing to the non-productive time (via behaviors, words, tone, expression, etc.) is displayed at 1208. The Individual NPT Breakdown 1210 consists of specific feedback for user 100, including the nature of their Word Choices 1212, characteristics of their Voice 1214, and properties such as facial expression, posture, motions, etc., which make up their Physical 1216 contribution to the interaction.

Application 500 shows user 100 a timeline 1218 of the interaction. Timeline 1218 represents the entire interaction from beginning to end and includes periodic vertical time markers to help orient user 100. Points of interest 1220 are displayed on the timeline as exclamation points, stars, or other symbols, and show the user where good or bad events happened during the interaction. In one embodiment, a first symbol is used to mark where the user performed especially well, and a different symbol is used to mark where the user did something that needs correction.

User 100 clicks or touches one of the points of interest 1220 to pull up a screen with additional information. A popup tells user 100 what went right or what went wrong at that point of the interaction. A video window allows user 100 to view their interaction beginning right before the point where something of interest occurred. User 100 clicks through all of the points of interest 1220 to see each aspect of the interaction that application 500 determined needs attention, and continues practicing to get better at productive conflict.

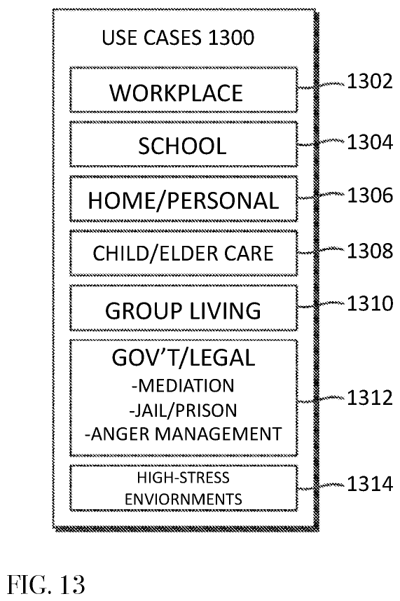

FIG. 13 shows examples of use cases 1300 for a conflict detection and intervention system. In exemplary implementations of this invention, this system first trains, and then provides ongoing real-time feedback to one or more human users, to reduce non-productive conflict and to improve each user's conflict resolution skills. For example, a conflict detection and intervention system may be used to increase safety and promote positive interactions in one or more of the following environments: workplace 1302, school 1304, personal spaces, such as in a home or on one's person, 1306, child care or elder care facilities 1308, group living situations of all types (halfway house, sober living, or even just a living space shared by roommates) 1310, government offices and functions, such as mediation, incarceration, or even court-ordered anger management 1312, or other high-stress environments where conflict resolution is particularly consequential (operating room, space station, etc.) 1314.

For example, a user may wear a wearable while working in a child care or elder care environment 1308 or as part of court-ordered anger management 1312 to subtly monitor the safety of those around them. Alternatively, a workplace 1302 may deploy a network of such devices, or a mediator 1312 may use the system to keep mediation productive without personally intervening (and thereby running the risk of appearing biased).

What is claimed is:

1. A method of interaction evaluation and feedback, comprising:
providing a interaction analysis engine;
using the interaction analysis engine to extract a plurality of features from a plurality of pre-recorded interactions;
providing manual ratings from conflict experts for an overall quality of each of the plurality of pre-recorded conflicts;
using a machine learning algorithm to compare the manual ratings of the pre-recorded conflicts to the plurality of features extracted from the pre-recorded conflicts, wherein the machine learning algorithm generates a predictive model defining correlations between the plurality of features and the manual ratings, and wherein the predictive model includes a plurality of rating scales with thresholds for the plurality of features, wherein a first rating scale for a first feature of the plurality of features includes a plurality of thresholds for rating the first feature and a first threshold of the plurality of thresholds is above a minimum and below a maximum of the first rating scale;
providing a computer system including a display monitor, a microphone, and a video capture device;
recording an interaction by the user onto the computer system using the microphone and the video capture device;
extracting the plurality of features from the interaction using the computer system;
analyzing the interaction by comparing the plurality of features extracted from the interaction against the thresholds of the rating scales of the predictive model; and
rendering feedback via an output transducer using the computer system in accordance with the environment configuration in response to at least one of the plurality of features.

2. The method of claim 1, further including:
providing a biometric device coupled to the computer system; and
extracting a second feature of the interaction based on data from the biometric device.

3. The method of claim 1, further including:
recording interactions for a plurality of users within an organization; and
presenting a dashboard that lists the plurality of users and a summary of activity of the plurality of users.

4. The method of claim 1, further including providing a second interface for Administrators prior to (or during) deployment, wherein the second interface allows the Administrator to select which features of interactions should be tracked.

5. The method of claim 1, wherein the plurality of features includes a body movement and a facial expression of the user.

6. A method of conflict intervention, comprising:
using an interaction analysis engine to extract a plurality of features from a plurality of prerecorded conflicts;
providing manual ratings from conflict resolution experts for an overall quality of each of the plurality of prerecorded conflicts;
using a machine learning algorithm to generate a predictive model defining correlations between the plurality of features and the manual ratings, wherein the predictive model includes a plurality of rating scales for the plurality of features, and wherein a first rating scale for a first feature of the plurality of features includes a plurality of thresholds for rating the first feature and a first threshold of the plurality of thresholds is above a minimum and below a maximum of the rating scale;
receiving a presentation by the user after generating the predictive model;
extracting the first feature from the interaction; and
analyzing the interaction by comparing the first feature against the plurality of thresholds on the first rating scale of the predictive model.

7. The method of claim 6, further including:
receiving a presentation material involved in the interaction; and
recording an amount of time that the interaction goes on, dividing the time into that which is characterized by non-productive conflict, and all other time in the interaction.

8. The method of claim 6, wherein the first feature relates to physical actions and gestures that support productive conflict or are neutral with respect to conflict.

9. The method of claim 6, further including displaying an interface allowing the user to select a mode of operation for receiving training, wherein the mode of operation is selectable from a list including the options of a lesson, guided practice, and self-practice.

10. A method of conflict resolution training, comprising:
providing a predictive model including a plurality of rating scales for a plurality of interaction features, wherein a first rating scale for a first feature of the plurality of interaction features includes a plurality of thresholds for rating the first feature;
receiving an interaction involving a user;
extracting the first feature from the interaction;
analyzing the interaction by comparing the first feature against the plurality of thresholds on the first rating scale of the predictive model; and
providing interventions, as necessary, and/or feedback as a result of analyzing the interaction.

11. The method of claim 10, wherein the first feature includes usage of facial expressions, motion, gestures and other physical manifestations of user's internal state.

12. The method of claim 10, further includes receiving a presentation material from the user, wherein the first feature includes the amount of non-constructive conflict potential within the presentation material.

13. A method of interaction feedback, comprising:
providing a predictive model including a plurality of rating scales for a plurality of interaction features, wherein a first rating scale for a first feature of the plurality of interaction features includes a plurality of thresholds for rating the first feature;
receiving an interaction from the users;
extracting the first feature from the presentation; and
analyzing the presentation by comparing the first feature against the plurality of thresholds on the first rating scale of the predictive model.

14. The method of claim 13, further including:
receiving presentations for a plurality of users within an organization, and presenting a dashboard that lists the plurality of users and a summary of activity of the plurality of users.

15. The method of claim 13, wherein the first feature relates to body movements and gestures of the user.

16. The method of claim 13, wherein the first feature relates to facial expressions of the user.

17. The method of claim 13, wherein the first feature relates to biometric outputs of the user.
